(19) United States
(12) Patent Application Publication
(10) Pub. No.: US 2025/0175960 A1
(43) Pub. Date: May 29, 2025

(54) SYSTEMS, APPARATUSES, METHODS, AND NON-TRANSITORY COMPUTER-READABLE STORAGE DEVICES FOR WIRELESS COMMUNICATION EMPLOYING DISTRIBUTIVE RESOURCE UNITS

(71) Applicant: HUAWEI TECHNOLOGIES CO., LTD., Shenzhen (CN)

(72) Inventors: Jung Hoon Suh, Kanata (CA); Yan Xin, Kanata, CA (US); Osama Aboul-Magd, Kanata, CA (US); Kwok Shum Au, Kanata, CA (US)

(21) Appl. No.: 18/956,566

(22) Filed: Nov. 22, 2024

Related U.S. Application Data
(60) Provisional application No. 63/602,419, filed on Nov. 23, 2023.

(51) Int. Cl. H04W 72/0453; H04L 5/00

(52) U.S. Cl. CPC H04W 72/0453; H04L 5/0007; H04L 5/0094

(57) ABSTRACT

A communication method has the step of: transmitting or receiving first data using a first resource unit (RU) of a plurality of first RUs in a first frequency band having a first bandwidth (BW) for orthogonal frequency division multiple access (OFDMA); wherein each of the plurality of first RUs has a plurality of subcarriers; and wherein, in the first RU, at least two neighboring subcarriers thereof are separated by one or more subcarriers belonging to one or more other first RUs of the plurality of first RUs.

### CROSS-REFERENCE TO RELATED APPLICATION

This application claims the benefit of U.S. Provisional Patent Application Ser. No. 63/602,419, filed Nov. 23, 2023, the content of which is incorporated herein by reference in its entirety.

### FIELD OF THE DISCLOSURE

The present disclosure relates generally to communication systems, apparatuses, methods, and non-transitory computer-readable storage devices, and in particular to systems, apparatuses, methods, and non-transitory computer-readable storage devices for wireless communication employing distributive resource units.

### BACKGROUND

Wireless communication systems such as IEEE 802.11ac (WI-FI® 5; WI-FI is a registered trademark of Wi-Fi Alliance, Austin, TX, USA) and IEEE 802.11ax (WI-FI® 6) systems need to meet the govern-regulated power spectral density (PSD) requirements, which lays the limit in the upper bound on the transmitter (TX) power at, for example, every one (1) megahertz (MHz). The total TX power has also been regulated.

In wireless communication systems (such as IEEE 802.11ax (WI-FI® 6) systems) using orthogonal frequency division multiple access (OFDMA; which uses orthogonal frequency division multiplexing (OFDM) for multiple access), the resource unit (RU) is the OFDMA scheduling unit. In conventional wireless communication technologies, a RU usually only occupies a sub-bandwidth of consecutive subcarriers of the OFDM frame according to the size of the RU. When using OFDMA, different RUs may be used with different TX power. However, the government-regulated PSD requirements limit the TX power that can be used in RUs.

### SUMMARY

According to one aspect of this disclosure, there is provided a communication method comprising: transmitting or receiving first data using a first resource unit (RU) of a plurality of first RUs in a first frequency band having a first bandwidth (BW) for orthogonal frequency division multiple access (OFDMA); wherein each of the plurality of first RUs comprises a plurality of subcarriers; and wherein, in the first RU, at least two neighboring subcarriers thereof are separated by one or more subcarriers belonging to one or more other first RUs of the plurality of first RUs.

In some embodiments, in in the first RU, at least two neighboring subcarriers thereof are separated by one or more subcarriers of one or more other first RUs of the plurality of first RUs.

According to one aspect of this disclosure, there is provided a communication method comprising: transmitting or receiving first data using one or more first resource units (RUs) of a plurality of first RUs in a first frequency band having a first bandwidth (BW) for orthogonal frequency division multiple access (OFDMA); wherein each of the plurality of first RUs comprises a plurality of subcarriers; and wherein, in each first RU of the plurality of first RUs, at least two neighboring subcarriers thereof are separated by one or more subcarriers belonging to one or more other first RUs of the plurality of first RUs.

In some embodiments, in each RU of the plurality of RUs, at least two neighboring subcarriers thereof are separated by one or more subcarriers of one or more other RUs of the plurality of RUS.

In some embodiments, the subcarriers of any one of the plurality of RUs are different from the subcarriers of any other one of the plurality of RUs; and the subcarriers of each of the plurality of RUs are substantially distributed over the entire first frequency band.

In some embodiments, the subcarriers of the plurality of first RUs are interleaved such that a subcarrier of one of the plurality of first RUs is an immediately adjacent subcarrier of another one of the plurality of first RUs.

In some embodiments, the first frequency band comprises a plurality of unusable subcarriers that are unusable for data and/or pilot transmission; and the subcarriers of each of the plurality of first RUs are equidistantly interleaved when the plurality of unusable subcarriers are uncounted.

In some embodiments, the first frequency band comprises a plurality of unusable subcarriers that are unusable for data and/or pilot transmission; and the unusable subcarriers and the plurality of first RUs in the first frequency band are substantially aligned with unusable subcarriers and a plurality of second RUs in a second frequency band, respectively, the second frequency band comprising the first frequency band and having a second BW different from the first BW.

In some embodiments, the unusable subcarriers comprise a plurality of guard subcarriers, a plurality of null subcarriers, and/or a plurality of direct-current (DC) subcarriers.

In some embodiments, the communication method further comprises: transmitting or receiving second data using one or more second RUs of a plurality of second RUs in a second frequency band; wherein the second frequency band comprises the first frequency band and has a second BW different from the first BW; wherein the subcarriers of each of the one or more first RUs are substantially distributed over the entire first frequency band; and wherein the subcarriers of each of the one or more second RUs are substantially distributed over the entire second frequency band.

In some embodiments, said transmitting or receiving the first data and said transmitting or receiving the second data are substantially at same time.

In some embodiments, the second data is transmitted in a physical layer protocol data unit (PPDU); the PPDU comprises a SIG field in a preamble of the PPDU; and the SIG field comprises an indication indicating that a portion of the second frequency band is also used as the first frequency band.

In some embodiments, the second frequency band comprises a third frequency band un-overlapped with the first frequency band; the communication method further comprises: transmitting or receiving third data using one or more third RUs in the third frequency band; and each of the one or more third RUs comprises, when unusable subcarriers are uncounted, a plurality of consecutive subcarriers.

According to one aspect of this disclosure, there is provided a method comprising: transmitting or receiving data using one or more resource units (RUs) of a plurality of RUs in a first frequency band having a first bandwidth (BW) for orthogonal frequency division multiple access (OFDMA); wherein each of the plurality of RUs comprises a plurality of subcarriers; wherein the subcarriers of any one of the plurality of RUs are different from the subcarriers of any other one of the plurality of RUs; and wherein the subcarriers of each of the plurality of RUs are substantially distributed over the entire frequency band.

In some embodiments, the first frequency band is a sub-band of a second frequency band, the second frequency band having a second BW greater than the first BW; the second frequency band has a punctured sub-band temporarily unavailable for the data and/or pilot transmission; and the first frequency band is selected from the second frequency band excluding the punctured sub-band.

In some embodiments, the second frequency band is partitionable to a plurality of sub-bands having a same BW; the punctured sub-band corresponds to one or more of the plurality of sub-bands; and the first frequency band comprises one or more of the plurality of sub-bands excluding the punctured sub-band.

In some embodiments, the second frequency band has an 80 Megahertz (MHz) BW and is partitionable to four sub-bands each having a 20 MHz BW; the punctured sub-band has a maximum of 20 MHz BW and the first frequency band has a 20 MHz or 40 MHz BW, or the punctured sub-band has a maximum of 40 MHz BW and the first frequency band has a 20 MHz or 40 MHz BW.

In some embodiments, the first frequency band has a 20 MHz or 40 MHz BW, and the second frequency band has an 80 MHz BW.

In some embodiments, the method further comprises: transmitting or receiving second data using one or more RUs of another plurality of RUs in a third frequency band; wherein the third frequency band is a sub-band of the second frequency band; wherein the third frequency band is selected from the second frequency band excluding the punctured sub-band; and wherein the second frequency band has an 80 MHz BW, the punctured sub-band has a maximum of 20 MHz BW, the first frequency band has a 20 MHz, and the third frequency band has a 40 MHz BW.

According to one aspect of this disclosure, there is provided one or more processors functionally connected to one or more non-transitory, computer-readable storage media comprising computer-executable instructions, wherein the instructions, when executed, cause the one or more processors to perform the above-described method.

According to one aspect of this disclosure, there is provided one or more non-transitory computer-readable storage devices comprising computer-executable instructions, wherein the instructions, when executed, cause one or more circuits, such as one or more processing units or one or more processors, to perform above-described methods.

According to one aspect of this disclosure, there is provided one or more circuits, such as one or more processing units or one or more processors, for performing for performing above-described methods.

Herein, various embodiments of distributive RUs (dRUs) and their arrangements are disclosed. In some embodiments, the dRUs and the arrangements thereof are for various BWs such as 20, 40, 80, 160, and 320 MHz BWs. The base size for the dRUs may be set to 57 tones and the larger-size dRUs may be arranged based on the 57-tone base dRU size. Thus, the base size of dRUs may not have to be bounded by the system throughput (which may affect the size of the rRU). Moreover, the dRUs and their arrangements provide improved communication performance while meeting the government-regulated PSD requirements.

With alignment of unusable tones and dRUs across various operating BWs (such as 20, 40, 80, 160, and/or 320 MHz BWs), STAs with different operating BWs may be scheduled together with suitable dRU tone plans.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIGS. 4 and 5 are plots showing the system-level Simulation results of spectral efficiency over the various resource unit (RU) sizes according to the IEEE channel types;

FIG. 6 is a schematic diagram showing the arrangement of 57-tone distributive resource units (dRUs) for a 20 megahertz (MHz) bandwidth of orthogonal frequency-division multiple access (OFDMA), according to some embodiments of this disclosure;

FIG. 7 is a schematic diagram showing the arrangement of 114-tone dRUs for a 20 MHz OFDMA bandwidth, according to some embodiments of this disclosure;

FIG. 8 is a schematic diagram showing the arrangement of 57-tone dRUs for a 40 MHz OFDMA bandwidth, according to some embodiments of this disclosure;

FIG. 9 is a schematic diagram showing the arrangement of 57-tone dRUs for an 80 MHz OFDMA bandwidth, according to some embodiments of this disclosure;

FIGS. 10A and 10B are a schematic diagram showing the arrangement of 57-tone dRUs for a 160 MHz OFDMA bandwidth, according to some embodiments of this disclosure;

FIGS. 11A to 11D are a schematic diagram showing the arrangement of 57-tone dRUs for a 320 MHz OFDMA bandwidth, according to some embodiments of this disclosure; and

FIG. 12 is a schematic diagram showing the arrangement of 60-tone dRUs for a 20 MHz OFDMA bandwidth, according to some embodiments of this disclosure.

### DETAILED DESCRIPTION

Embodiments disclosed herein relate to systems, apparatuses, methods, and non-transitory computer-readable storage devices for wireless communication employing distributive resource units. The wireless communication systems, apparatuses, and methods disclosed herein may be any suitable systems, apparatuses, and methods for transmitting wireless signals. Examples of such systems may be wireless local-area network (WLAN) Ultra High Reliability (UHR) systems (for example, IEEE 802.11bn or WI-FI® 8 systems), 5G or 6G wireless mobile communication systems, and the like.

### A. System Structure

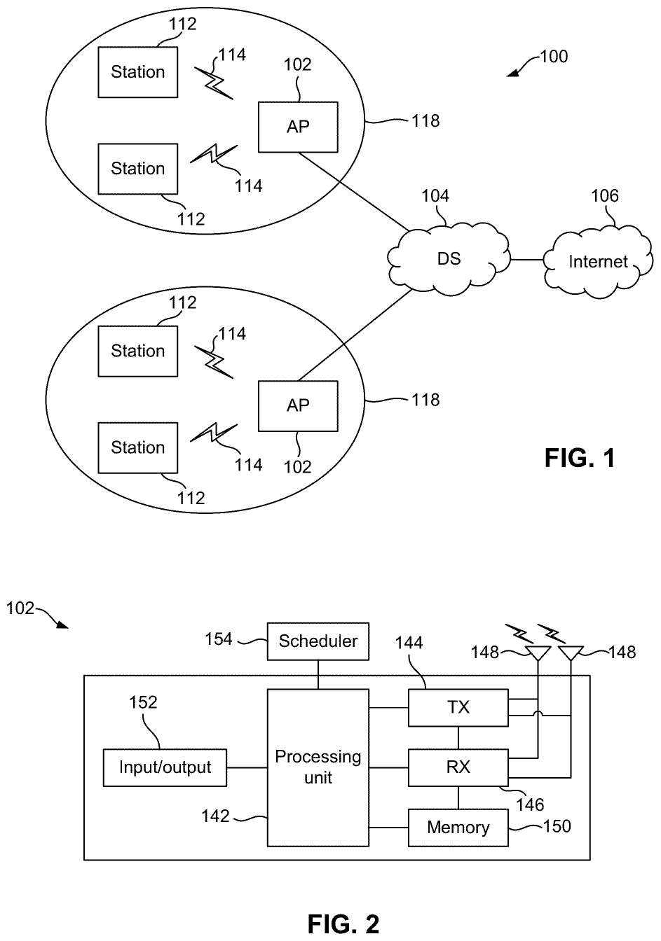

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

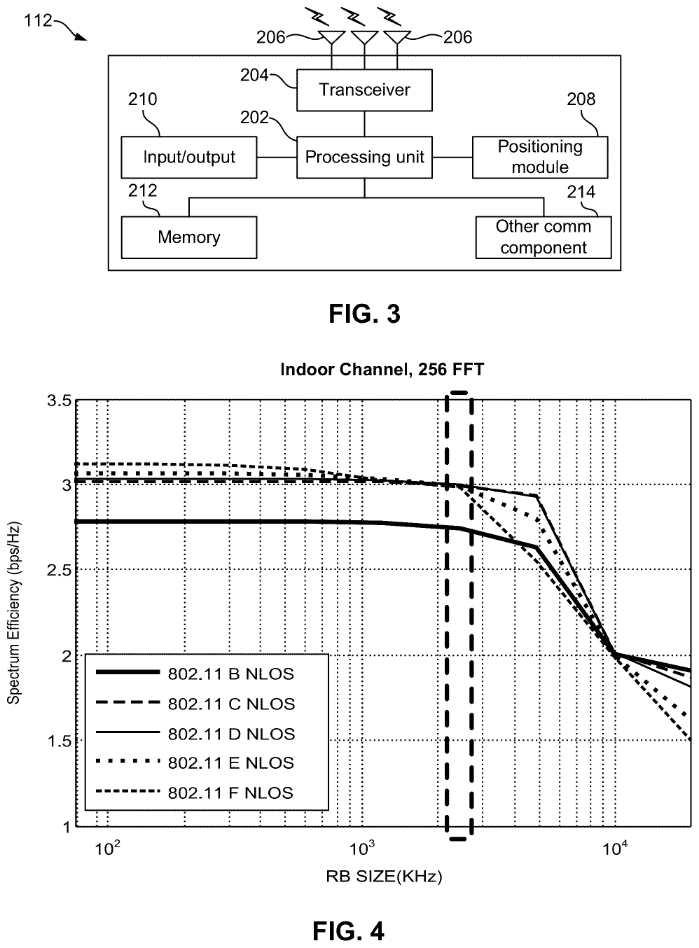

FIG. 2 is a simplified schematic diagram of an AP 102. As shown, the AP 102 comprises at least one processing unit 142 (also denoted at least one “processor”), at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

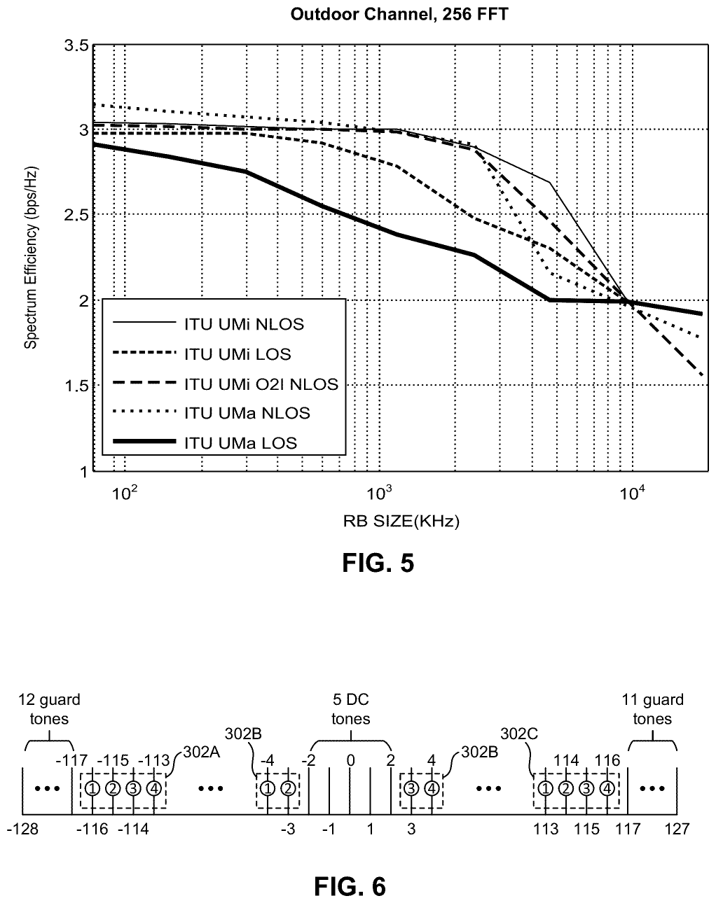

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subchannels for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Orthogonal Frequency Division Multiple Access and Resource Units

### B-1. Conventional Arrangement of Resource Units

Some wireless communication systems such as IEEE 802.11ax (WI-FI® 6) systems use orthogonal frequency division multiple access (OFDMA) for multiple access. Generally, OFDMA uses orthogonal frequency division multiplexing (OFDM) for multiple users to transmit data at the same time.

For example, in an IEEE 802.11ax system, a device such as an AP 102 or a STA 112 transmits data using physical layer protocol data units (PPDUs). A PPDU contains a preamble and a data field containing an OFDM symbol. As those skilled in the art understand, an OFDM symbol combines data elements into a plurality of subcarriers (also called “tones”) and uses the so-called cyclic prefix for combating inter-symbol interferences. The number of tones in an OFDM symbol depends on the bandwidth (BW) thereof. In IEEE 802.11ax, the subcarrier spacing is 78.125 kilohertz (kHz), and the OFDM BW (that is, the BW of OFDM symbols; also denoted “OFDMA BW” when OFDMA is used) may be 20 MHz, 40 MHz, or 80 MHz. Correspondingly, the number of OFDM tones (that is, the tones in an OFDM symbol; also denoted “OFDMA tones” hereinafter when OFDMA is used) may be 256, 512, or 1024. Some of these tones are unused, including direct-current (DC) tones (also called direct-conversion tones, which include the tone whose frequency is equal to the RF carrier frequency, and some neighboring tones thereof), guard tones, and null tones. Therefore, the usable tones are generally a subset of the total OFDM tones.

When OFDMA is used, the usable OFDMA tones or subcarriers are partitioned into a plurality of resource units (RUs) for assigning to a plurality of users. In prior art, each RU (denoted “regular RU” or “rRU” hereinafter) consists of a plurality of consecutive tones. The smallest number of tones of a RU is 26 tones which forms the base RU size and the bigger size of RU has been built up based on the 26-tone RU.

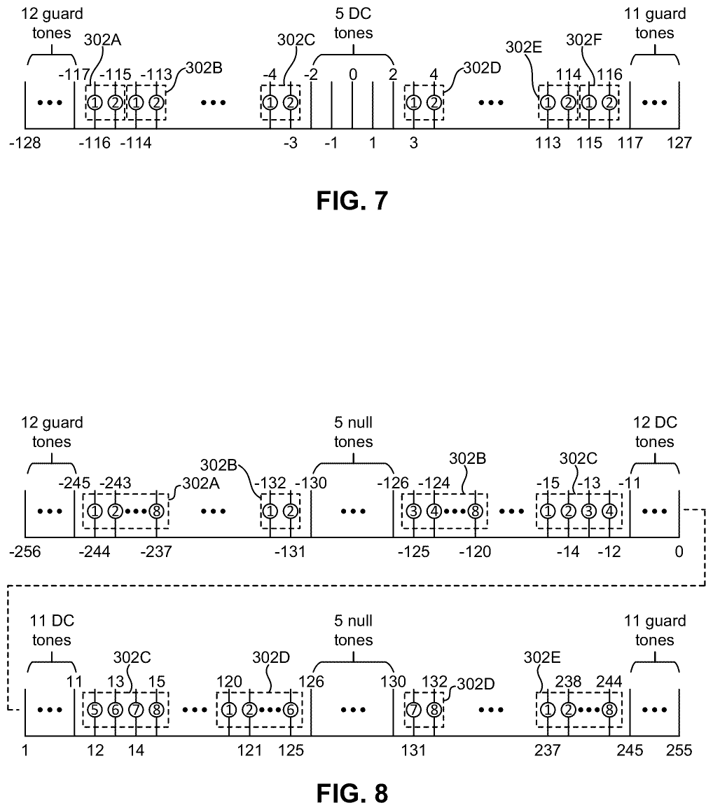

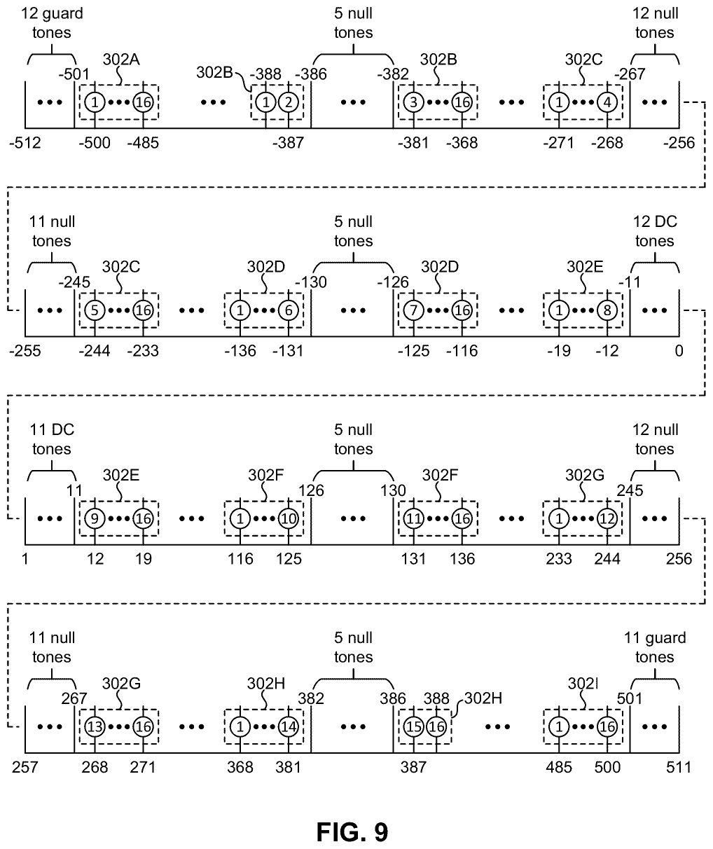

The document entitled “OFDMA Numerology and Structure” by S. Azizi et. al., published by IEEE 802.11 TGax, May 2015, 15/330r5, provides system-level simulation results of spectral efficiency over various RU sizes according to the IEEE channel types, reproduced herein as FIGS. 4 and 5, for evaluating the spectrum efficiency over the various selections of the smallest OFDMA RU size. It is observed that spectrum efficiency starts to drop from the point of 2.5 MHz RU size, and thus, the size of the smallest OFDMA RU needs to be around 2.5 MHz. It is why the 26-tone has been set as the base RU size.

### B-2. Distributive Resource Units

In some embodiments, the wireless communication system 100 or more specifically the APs 102 and STAs 112 thereof may use distributive RUs (dRUs), wherein a dRU may comprise nonconsecutive subcarriers. In other words, among the subcarriers or tones assigned to the dRU, at least two neighboring tones thereof are nonconsecutive, and separated by one or more tones not belonging to the dRU (that is, separated by one or more unusable tones and/or one or more tones of other dRUs). Thus, the subcarriers of the dRU may be allocated across the entire OFDMA BW. In other words, the nominal BW (from the lowest tone to the highest tone) of the dRU may occupy the entire OFDMA BW regardless of the size of the dRU. Moreover, the base RU size in these embodiments does not have to be limited to 26 tones for dRU since the subcarriers get spread across the entire OFDMA BW.

In these embodiments, the government-regulated PSD requirements may be applied based on the OFDMA BW where the dRU-based OFDMA is scheduled, which is especially effective for the uplink (UL) OFDMA PPDU. Consequently, the frequency diversity gain may be achieved with the spread subcarriers of the dRU across the entire PPDU, thereby providing additional benefit. The dRU may require a different tone plan from the incumbent 802.11 high efficiency (HE) and extremely high throughput (EHT) OFDMA tone plan, and may require new hardware implementation. Herein, a tone plan is a specific arrangement of the dRUs within the OFDMA BW.

In the following, various embodiments of dRU tone plans according to various OFDMA BWs are described.

In some embodiments, the usable OFDMA tones are partitioned to a plurality of dRUs in a manner such that:
the unusable tones such as the DC tones, guard tones, null tones, and the like are aligned between different OFDMA BWs, such that mixed scheduling between the STAs 112 using rRUs and the STAs using dRUs may be feasible; and
the tones of the dRUs are interleaved; in other words, if the usable OFDMA tones are partitioned into N dRUs, and all usable tones are indexed consecutively (that is, the indexing not including the unusable tones) from the lowest tone to the highest tone, then the i-th dRU (i=1, 2, . . . , N) comprises the following set of usable tones:

$$[ i , i + N , i + 2 N , i + 3 N , … ] \qquad ( 1 )$$

Thus, dRUs of various sizes may be defined for various OFDMA BWs.

B-3. Arrangement of dRUs for 20 MHz OFDMA BW

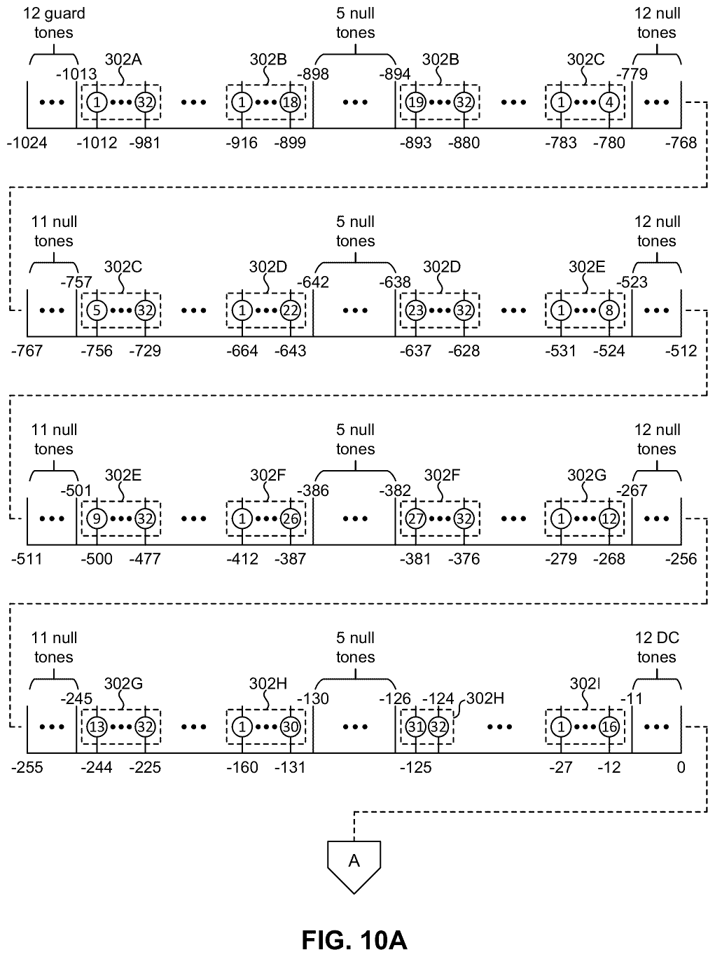

FIG. 6 shows the 57-tone dRU arrangement for 20 MHz OFDMA BW (having 256 tones in total, based on the 78.125 kHz subcarrier spacing). In FIG. 6 and subsequent figures, all tones (including all usable and unusable tones) are indexed consecutively, starting from the carrier frequency numbered or otherwise indexed as tone 0, and tones on the lower half of the BW (with respect to the carrier frequency) numbered or otherwise indexed as negative integers and tones on higher half of the BW numbered or otherwise indexed as positive integers. Moreover, the tones of different dRUs are represented by solid lines with different circle-enclosed numbers, wherein the tones having same number belong to the same dRU.

As shown, the 20 MHz OFDMA BW has 28 unusable tones and 228 usable tones. The 28 unusable tones include 12 guard tones on the lower end of the BW, 11 guard tones on the higher ends of the BW, and 5 DC tones (including one tone at the carrier frequency and two tones on each side thereof). The 228 usable tones include 114 tones on each side of the carrier frequency.

The 228 usable tones are partitioned into four interleaved dRUs each having 57 tones. With such partitioning, the 228 usable tones exhibit a four-tone pattern 302 repeated 57 times (FIG. 6 only shows three patterns 302A, 302B, and 302C for ease of illustration). The four-tone pattern 302 comprise one tone of each dRU. The four tones of four different dRUs are in the same order for all 57 pattern-repeats. As will be illustrated below, other dRU arrangements also exhibit similar patterns (with different sizes of the patterns) and pattern-repeats.

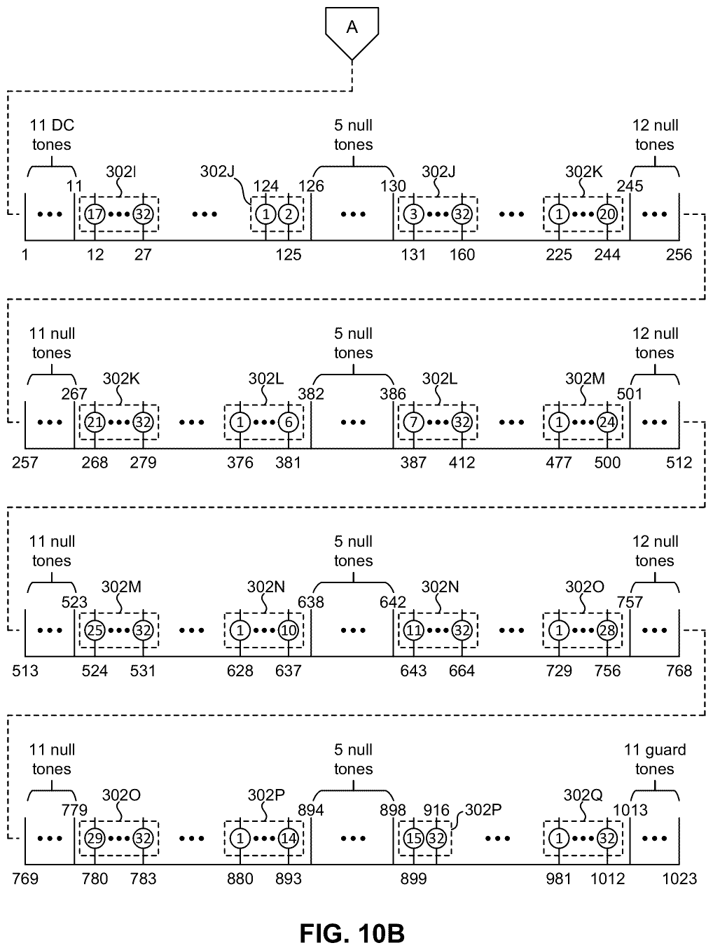

The 57-tone dRU arrangement may be used as the basis for forming dRUs of other sizes. For example, FIG. 7 shows the 114-tone dRU arrangement for 20 MHz OFDMA BW wherein the 20 MHz OFDMA BW is partitioned into two interleaved dRUs each having 114 tones. For ease of illustration, FIG. 7 only shows six repeats (302A to 302F) of the two-tone pattern 302.

As another example, all 228 usable tones may form a single dRU.

B-4. Arrangement of dRUs for 40 MHz OFDMA BW

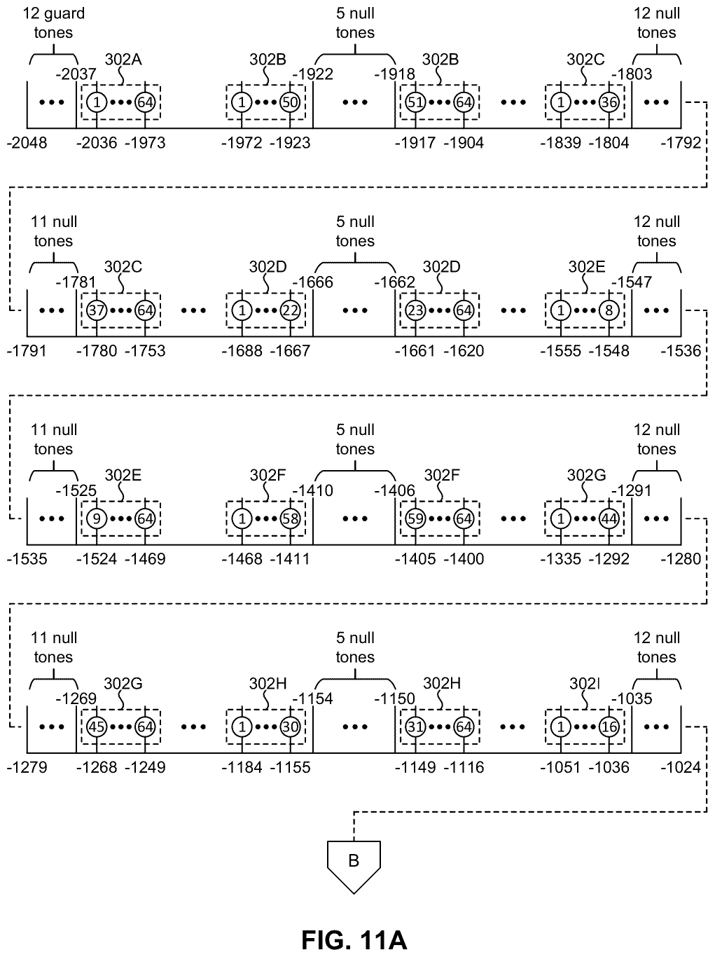

FIG. 8 shows the 57-tone dRU arrangement for 40 MHz OFDMA BW (having 512 tones in total, based on the 78.125 kHz subcarrier spacing). As shown, the 40 MHz OFDMA BW has 56 unusable tones and 456 usable tones. The unusable tones include 12 guard tones on the lower end of the BW, 11 guard tones on the higher ends of the BW, 23 DC tones (including one tone at the carrier frequency and 11 tones on each side thereof), and two sets of null tones each having 5 consecutive tones. One set of null tones are in the middle of the lower 20 MHz frequency portion (with respect to the carrier frequency) and the other set of null tones are in the middle of higher 20 MHz frequency portion. The 456 usable tones include 228 tones on each side of the carrier frequency.

The 456 usable tones are partitioned into eight interleaved dRUs each having 57 tones. For ease of illustration, FIG. 8 only shows five repeats (302A to 302E) of the eight-tone pattern 302.

As those skilled in the art will appreciate, in the dRU arrangements shown in FIGS. 6 and 7, the unusable tones are aligned. In other words, the unusable tones in the 57-tone dRU arrangement are the same unusable tones in the 114-tone dRU arrangement. Moreover, comparing the dRU arrangements shown in FIGS. 6 and 8 or FIGS. 7 and 8, the unusable tones in the dRU arrangement for the 20 MHz BW are substantially aligned with the unusable tones in the dRU arrangement for the 40 MHz BW. In other words, the unusable tones in the 57-tone dRU arrangement or the 114-tone dRU arrangement are substantially the same unusable tones in the lower or the higher 20 MHz frequency portion of the 57-tone dRU arrangement for the 40 MHz BW.

FIGS. 6 to 8 also show that the dRU arrangements disclosed herein (including above-described dRU arrangements for 20 MHz BW and 40 MHz BW, and the dRU arrangements described below for larger BWs) also ensure the alignment of dRUs of different sizes. In other words, the tones of a larger-size dRU substantially correspond to all tones of a plurality of smaller-size dRUs. That is, the entirety of a smaller-size dRU corresponds to a portion of a single larger-size dRU, and no smaller-size dRU would correspond to portions of multiple larger-size dRUs. In other words, a smaller-size dRU is completely “within” a larger-size dRU.

More specifically, the tones of a larger-size dRU substantially correspond to 2ⁿ smaller component dRUs that are all identical in tone number and equidistantly interleaved. Herein, the term “equidistantly interleaved” means that a tone of a component dRU is spaced from the closest tone of another component dRU by 1/(2ⁿ) the tone spacing of consecutive tones of any component dRU. Stated another way, 2ⁿ dRUs may be combined into a larger dRU if their frequency combs are uniformly mutually interdigitated.

In still other words, the larger BW (such as the 40 MHz BW) is an integer multiple of a smaller BW (such as the 20 MHz BW). The larger BW may be partitioned into a plurality of equal-bandwidth portions each corresponding to the smaller BW (that is, each portion of the larger BW having the same bandwidth as the smaller BW). The unusable tones and dRUs of each portion of the larger BW are substantially aligned with the unusable tones and dRUs of the smaller BW, respectively, with the meaning of “align” or “alignment” same as those terms described above.

The 57-tone dRU arrangement may be used as the basis for forming dRUs of other sizes, such as four 114-tone dRUs (each 114-tone dRU aligned with or otherwise corresponding to two equidistantly interleaved 57-tone dRUs), two 228-tone dRUs (each 228-tone dRU aligned with or otherwise corresponding to four equidistantly interleaved 57-tone dRUs), and one 456-tone dRU (having all usable tones; that is, aligned with or otherwise corresponding to eight (8) equidistantly interleaved 57-tone dRUs). The unusable tones in these dRU arrangements are substantially aligned, and are also substantially aligned with the unusable tone in the dRU arrangements described above. The dRUs in different dRU arrangements are also aligned.

Such substantial alignment of unusable tones allow mix-bandwidth scheduling (that is, different devices such as different STAs 112 may use different operating BWs for transmission at the same time). For example, the STAs 102 using the 20 MHz operating BW may be scheduled in either the lower 20 MHz frequency portion or the higher 20 MHz frequency portion of the 40 MHz dRU based PPDU.

An indication may be included in the SIG field of the PPDU for indicating that the PPDU may have been scheduled with the 20 MHz dRU based tone plan in both lower and upper 20 MHz frequency portions of the 40 MHz PPDU. That is, both the STAs using the 20 MHz operating BW and the STAs using the 40 MHz operating BW may be scheduled in one 40 MHz PPDU. The BW indication in the SIG field may be still 40 MHz, and the STAs using the 20 MHz operating BW and the STAs using the 40 MHz operating BW may both be scheduled in either upper or lower 20 MHz frequency portion of the 40 MHz PPDU using the 20 MHz dRU tone plan. Thus, both the 20 MHz dRU tone plan and the 40 MHz dRU tone plan may be mix-used in one 40 MHz PPDU.

In some embodiments where mix-bandwidth scheduling is used, one of the lower or higher 20 MHz frequency portion may be scheduled as dRUs and the other one of the lower or higher 20 MHz frequency portion may be scheduled as rRUs.

B-5. Arrangement of dRUs for 80 MHz OFDMA BW

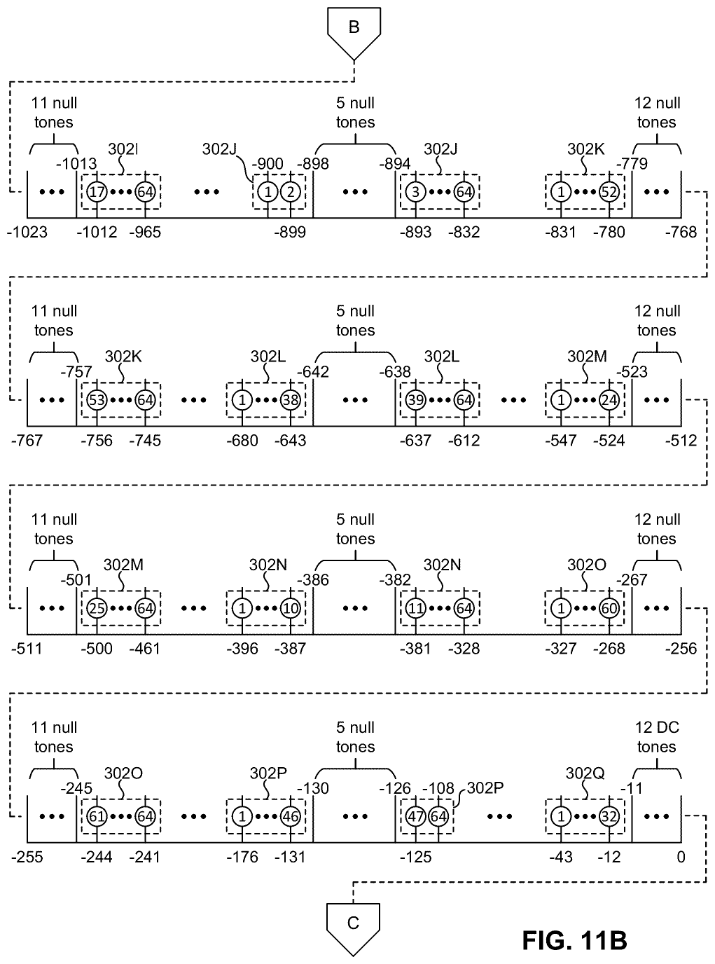

FIG. 9 shows the 57-tone dRU arrangement for 80 MHz OFDMA BW (having 1024 tones in total, based on the 78.125 kHz subcarrier spacing). As shown, the 80 MHz OFDMA BW has 112 unusable tones and 912 usable tones. The 912 usable tones are partitioned into 16 interleaved dRUs each having 57 tones. For ease of illustration, FIG. 9 only shows nine repeats (302A to 302I) of the 16-tone pattern 302.

As can be seen, the 80 MHz OFDMA BW may be partitioned into four equal-bandwidth portions each having a 20 MHz bandwidth (corresponding to the above described 20 MHz OFDMA BW). The unusable tones and dRUs of each portion of the 80 MHz OFDMA BW substantially align with those of the 20 MHz OFDMA, respectively.

The 80 MHz OFDMA BW may also be partitioned into two equal-bandwidth portions each having a 40 MHz bandwidth (corresponding to the above described 40 MHz OFDMA BW). The unusable tones and dRUs of each portion of the 80 MHz OFDMA BW substantially align with those of the 40 MHz OFDMA, respectively.

The 57-tone dRU arrangement may be used as the basis for forming dRUs of other sizes, such as eight 114-tone dRUs (each 114-tone dRU aligned with or otherwise corresponding to two equidistantly interleaved 57-tone dRUs), four 228-tone dRUs (each 228-tone dRU aligned with or otherwise corresponding to four equidistantly interleaved 57-tone dRUs), two 456-tone dRU (each 456-tone dRU aligned with or otherwise corresponding to eight equidistantly interleaved 57-tone dRUs), and one 912-tone dRU (having all usable tones; that is, aligned with or otherwise corresponding to 16 equidistantly interleaved 57-tone dRUs). The unusable tones and dRUs in these dRU arrangements are substantially aligned, and are also substantially aligned with the unusable tone in the dRU arrangements described above.

B-6. Arrangement of dRUs for 160 MHz OFDMA BW

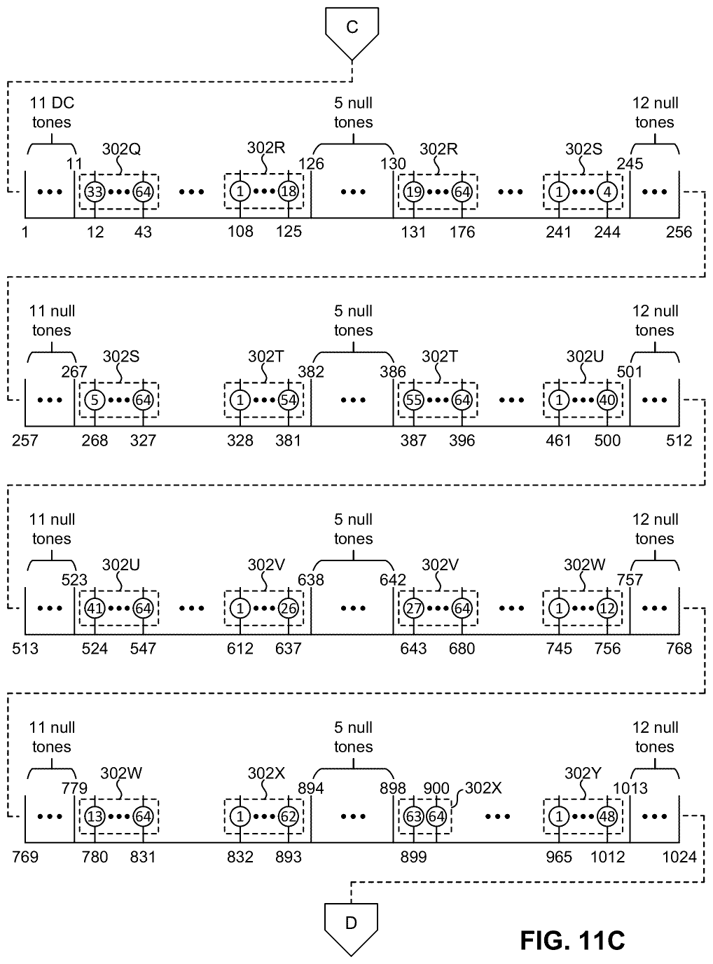

FIGS. 10A and 10B show the 57-tone dRU arrangement for 160 MHz OFDMA BW (having 2048 tones in total, based on the 78.125 kHz subcarrier spacing). As shown, the 160 MHz OFDMA BW has 224 unusable tones and 1824 usable tones. The 1824 usable tones are partitioned into 32 interleaved dRUs each having 57 tones. For ease of illustration, FIGS. 10A and 10B only show 17 repeats (302A to 302Q) of the 32-tone pattern 302.

As can be seen, the 160 MHz OFDMA BW may be partitioned into eight equal-bandwidth portions each having a 20 MHz bandwidth (corresponding to the above described 20 MHz OFDMA BW). The unusable tones and dRUs of each portion of the 160 MHz OFDMA BW substantially align with those of the 20 MHz OFDMA, respectively.

The 160 MHz OFDMA BW may also be partitioned into four equal-bandwidth portions each having a 40 MHz bandwidth (corresponding to the above described 40 MHz OFDMA BW). The unusable tones and dRUs of each portion of the 160 MHz OFDMA BW substantially align with those of the 40 MHz OFDMA, respectively.

The 160 MHz OFDMA BW may further be partitioned into two equal-bandwidth portions each having an 80 MHz bandwidth (corresponding to the above described 80 MHz OFDMA BW). The unusable tones and dRUs of each portion of the 160 MHz OFDMA BW substantially align with those of the 80 MHz OFDMA, respectively.

The 57-tone dRU arrangement may be used as the basis for forming dRUs of other sizes, such as sixteen 114-tone dRUs (each 114-tone dRU aligned with or otherwise corresponding to two equidistantly interleaved 57-tone dRUs), eight 228-tone dRUs (each 228-tone dRU aligned with or otherwise corresponding to four equidistantly interleaved 57-tone dRUs), four 456-tone dRU (each 456-tone dRU aligned with or otherwise corresponding to eight equidistantly interleaved 57-tone dRUs), two 912-tone dRU (each 912-tone dRU aligned with or otherwise corresponding to 16 equidistantly interleaved 57-tone dRUs), and one 1824-tone dRU (having all usable tones; that is, aligned with or otherwise corresponding to 32 equidistantly interleaved 57-tone dRUs). The unusable tones and dRUs in these dRU arrangements are substantially aligned, and are also substantially aligned with the unusable tone in the dRU arrangements described above.

B-6. Arrangement of dRUs for 320 MHz OFDMA BW

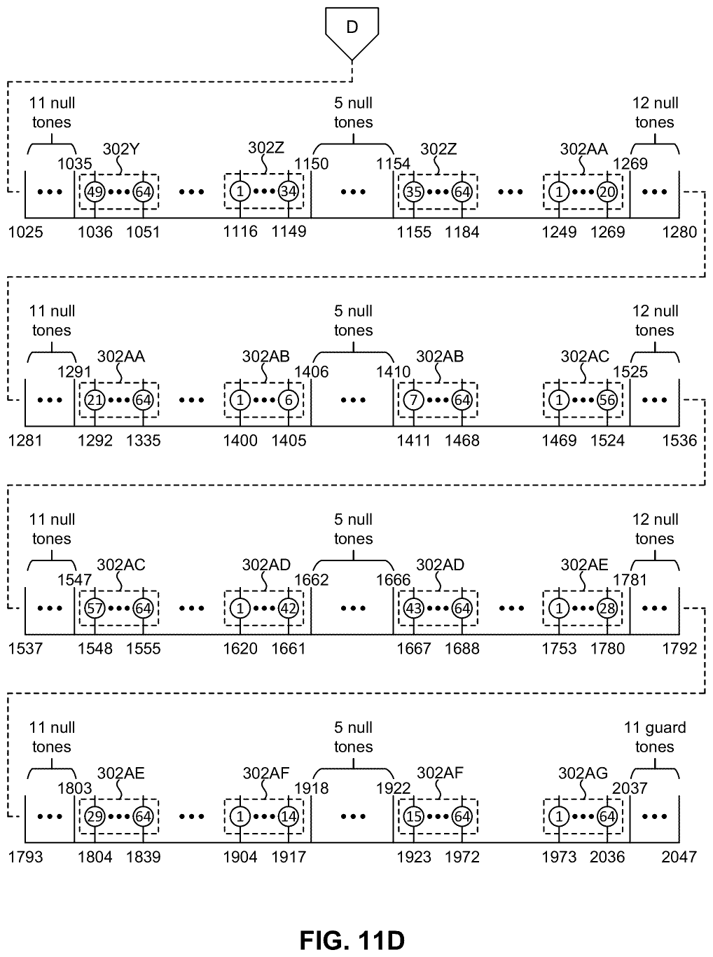

FIGS. 11A to 11D show the 57-tone dRU arrangement for 320 MHz OFDMA BW (having 4096 tones in total, based on the 78.125 kHz subcarrier spacing). As shown, the 320 MHz OFDMA BW has 448 unusable tones and 3648 usable tones. The 3648 usable tones are partitioned into 64 interleaved dRUs each having 57 tones. For ease of illustration, FIGS. 11A to 11D only show 34 repeats (302A to 302AG) of the 64-tone pattern 302.

As can be seen, the 320 MHz OFDMA BW may be partitioned into 16 equal-bandwidth portions each having a 20 MHz bandwidth (corresponding to the above described 20 MHz OFDMA BW). The unusable tones and dRUs of each portion of the 320 MHz OFDMA BW substantially align with those of the 20 MHz OFDMA, respectively.

As can be seen, the 320 MHz OFDMA BW may also be partitioned into eight equal-bandwidth portions each having a 40 MHz bandwidth (corresponding to the above described 40 MHz OFDMA BW). The unusable tones and dRUs of each portion of the 320 MHz OFDMA BW substantially align with those of the 40 MHz OFDMA, respectively.

The 320 MHz OFDMA BW may further be partitioned into four equal-bandwidth portions each having an 80 MHz bandwidth (corresponding to the above described 80 MHz OFDMA BW). The unusable tones and dRUs of each portion of the 320 MHz OFDMA BW substantially align with those of the 80 MHz OFDMA, respectively.

The 320 MHz OFDMA BW may still further be partitioned into two equal-bandwidth portions each having a 160 MHz bandwidth (corresponding to the above described 160 MHz OFDMA BW). The unusable tones and dRUs of each portion of the 320 MHz OFDMA BW substantially align with those of the 160 MHz OFDMA, respectively.

The 57-tone dRU arrangement may be used as the basis for forming dRUs of other sizes, such as thirty-two 114-tone dRUs (each 114-tone dRU aligned with or otherwise corresponding to two equidistantly interleaved 57-tone dRUs), sixteen 228-tone dRUs (each 228-tone dRU aligned with or otherwise corresponding to four equidistantly interleaved 57-tone dRUs), eight 456-tone dRU (each 456-tone dRU aligned with or otherwise corresponding to eight equidistantly interleaved 57-tone dRUs), four 912-tone dRU (each 912-tone dRU aligned with or otherwise corresponding to 16 equidistantly interleaved 57-tone dRUs), two 1824-tone dRU (each 1824-tone dRU aligned with or otherwise corresponding to 32 equidistantly interleaved 57-tone dRUs), and one 3648-tone dRU (having all usable tones; that is, aligned with or otherwise corresponding to 64 equidistantly interleaved 57-tone dRUs). The unusable tones and dRUs in these dRU arrangements are substantially aligned, and are also substantially aligned with the unusable tone in the dRU arrangements described above.

### B-7. Preamble Puncturing

In some embodiments, preamble puncturing may be used for improving spectral efficiency by disabling or otherwise excluding a portion or sub-band of the spectrum channel (called a “punctured” portion or sub-band) to make it temporarily unavailable for the data and/or pilot transmission, so as to allow an AP 102 or a STA 112 to use other portions of the spectrum channel for avoiding interference. In these embodiments, the shorter-BW dRU arrangements may be used in higher OFDMA BW individually by applying the shorter-BW dRU arrangements or tone plans to non-punctured frequency portion and schedule the PPDU to the same STA.

For example, for 20+40 MHz puncturing case in 80 MHz PPDU, the 20 MHz dRU tone plan and 40 MHz dRU tone plan may be applied to the non-punctured frequency portion of the 80 MHz BW, and schedule the PPDU to the same STA.

B-8. 60-Tone dRUs Arrangement for 20 MHz OFDMA BW

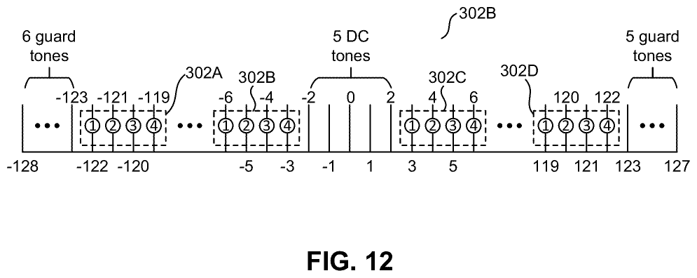

Those skilled in the art will appreciate that, in various embodiments, various dRU arrangements are readily available. For example, FIG. 12 shows a 60-tone dRU arrangement for 20 MHz OFDMA BW (having 256 tones in total, based on the 78.125 kHz subcarrier spacing).

As shown, the 20 MHz OFDMA BW has 16 unusable tones and 240 usable tones. The 16 unusable tones include 6 guard tones on the lower end of the BW, 5 guard tones on the higher ends of the BW, and 5 DC tones (including one tone at the carrier frequency and two tones on each side thereof). The 240 usable tones include 120 tones on each side of the carrier frequency.

The 240 usable tones are partitioned into four interleaved dRUs each having 60 tones. For ease of illustration, FIG. 12 only shows four repeats (302A to 302D) of the four-tone pattern 302.

The 60-tone dRU arrangement may be used as the basis for forming dRUs of other sizes such as 120-tone dRU arrangement for 20 MHz OFDMA BW, wherein each 120-tone dRU corresponds to two equidistantly interleaved 60-tone dRUs.

Herein, various embodiments of dRUs and their arrangements are disclosed. In some embodiments, the dRUs and the arrangements thereof are for various BWs such as 20, 40, 80, 160, and 320 MHz BWs. The base size for the dRUs may be set to 57 tones and the larger-size dRUs may be arranged based on the 57-tone base dRU size. Thus, the base size of dRUs may not have to be bounded by the system throughput (which may affect the size of the rRU). Moreover, the dRUs and their arrangements provide improved communication performance while meeting the government-regulated PSD requirements.

With alignment of unusable tones and dRUs across various operating BWs (such as 20, 40, 80, 160, and/or 320 MHz BWs), STAs 112 with different operating BWs may be scheduled together with suitable dRU tone plans.

With the embodiments of dRUs and the arrangements thereof disclosed herein, a device such as a STA 112 may obtain an indication of one or more dRUs (for example, assigned by an AP 102), and then use the obtained dRUs to transmit data to the AP 102.

### C. Acronym Key

| | Acronym/Abbreviation/ |
|---|---|
| Full Name | Initialism |
| Power Spectral Density | PSD |
| Federal Communications Commission | FCC |
| Transmitter | TX |
| Mega Hertz | MHz |
| Resource Unit | RU |
| Distributive Resource Unit | dRU |
| Regular Resource Unit | rRU |
| Orthogonal Frequency Division Multiple | OFDMA |
| Access | |
| Uplink | UL |
| Bandwidth | BW |
| PHY Protocol Data Unit | PPDU |
| High Efficiency (11ax, Wi-Fi 6) | HE |
| Extremely High Throughput (11be, Wi-Fi 7) | EHT |

Those skilled in the art will appreciate that, in some embodiments, the methods disclosed herein may be implemented as one or more circuits of a module, a device, an apparatus, a system, and/or the like. In some embodiments, the methods disclosed herein may be implemented as computer-executable instructions stored in one or more non-transitory computer-readable storage devices such that, the instructions, when executed, may cause one or more circuits to perform the methods disclosed herein.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method comprising:
transmitting or receiving data using one or more resource units (RUs) of a plurality of RUs in a first frequency band having a first bandwidth (BW) for orthogonal frequency division multiple access (OFDMA);
wherein each of the plurality of RUs comprises a plurality of subcarriers;
wherein the subcarriers of any one of the plurality of RUs are different from the subcarriers of any other one of the plurality of RUs;
wherein the subcarriers of each of the plurality of RUs are substantially distributed over the entire first frequency band;
wherein the first frequency band is a sub-band of a second frequency band, the second frequency band having a second BW greater than the first BW;
wherein the second frequency band has a punctured sub-band temporarily unavailable for the data and/or pilot transmission; and
wherein the first frequency band is selected from the second frequency band excluding the punctured sub-band.

2. One or more processors functionally connected to one or more non-transitory, computer-readable storage media comprising computer-executable instructions, wherein the instructions, when executed, cause the one or more processors to perform the method of claim 1.

3. One or more non-transitory computer-readable storage media comprising computer-executable instructions, wherein the instructions, when executed, cause one or more processors to perform the method of claim 1.

4. The one or more non-transitory computer-readable storage media of claim 3, wherein the second frequency band is partitionable to a plurality of sub-bands having a same BW;
wherein the punctured sub-band corresponds to one or more of the plurality of sub-bands; and
wherein the first frequency band comprises one or more of the plurality of sub-bands excluding the punctured sub-band.

5. The one or more non-transitory computer-readable storage media of claim 3, wherein the second frequency band has an 80 Megahertz (MHz) BW and is partitionable to four sub-bands each having a 20 MHz BW;
wherein the punctured sub-band has a maximum of 20 MHz BW and the first frequency band has a 20 MHz or 40 MHz BW, or the punctured sub-band has a maximum of 40 MHz BW and the first frequency band has a 20 MHz or 40 MHz BW.

6. The one or more non-transitory computer-readable storage media of claim 3, wherein the first frequency band has a 20 MHz or 40 MHz BW, and the second frequency band has an 80 MHz BW.

7. The one or more non-transitory computer-readable storage media of claim 3, wherein the method further comprises:
transmitting or receiving second data using one or more RUs of another plurality of RUs in a third frequency band;
wherein the third frequency band is a sub-band of the second frequency band; and
wherein the third frequency band is selected from the second frequency band excluding the punctured sub-band;
wherein the second frequency band has an 80 MHz BW, the punctured sub-band has a maximum of 20 MHz BW, the first frequency band has a 20 MHZ, and the third frequency band has a 40 MHz BW.

8. A communication method comprising:
transmitting or receiving first data using one or more first resource units (RUs) of a plurality of first RUs in a first frequency band having a first bandwidth (BW) for orthogonal frequency division multiple access (OFDMA);
wherein each of the plurality of first RUs comprises a plurality of subcarriers; and
wherein, in each first RU of the plurality of first RUs, at least two neighboring subcarriers thereof are separated by one or more subcarriers belonging to one or more other first RUs of the plurality of first RUs.

9. The communication method of claim 7, wherein the first frequency band comprises a plurality of unusable subcarriers that are unusable for data and/or pilot transmission; and
wherein the unusable subcarriers and the plurality of first RUs in the first frequency band are substantially aligned with unusable subcarriers and a plurality of second RUs in a second frequency band, respectively, the second frequency band comprising the first frequency band and having a second BW different from the first BW.

10. The communication method of claim 7 further comprising:
transmitting or receiving second data using one or more second RUs of a plurality of second RUs in a second frequency band;
wherein the second frequency band comprises the first frequency band and has a second BW different from the first BW;
wherein the subcarriers of each of the one or more first RUs are substantially distributed over the entire first frequency band; and
wherein the subcarriers of each of the one or more second RUs are substantially distributed over the entire second frequency band.

11. One or more processors functionally connected to one or more non-transitory, computer-readable storage media comprising computer-executable instructions, wherein the instructions, when executed, cause the one or more processors to perform the method of claim 7.

12. The one or more processors of claim 10, wherein the subcarriers of the plurality of first RUs are interleaved such that a subcarrier of one of the plurality of first RUs is an immediately adjacent subcarrier of another one of the plurality of first RUs.

13. The one or more processors of claim 10, wherein the first frequency band comprises a plurality of unusable subcarriers that are unusable for data and/or pilot transmission; and
wherein the unusable subcarriers and the plurality of first RUs in the first frequency band are substantially aligned with unusable subcarriers and a plurality of second RUs in a second frequency band, respectively, the second frequency band comprising the first frequency band and having a second BW different from the first BW.

14. The one or more processors of claim 10 further comprising:
transmitting or receiving second data using one or more second RUs of a plurality of second RUs in a second frequency band;
wherein the second frequency band comprises the first frequency band and has a second BW different from the first BW;
wherein the subcarriers of each of the one or more first RUs are substantially distributed over the entire first frequency band; and
wherein the subcarriers of each of the one or more second RUs are substantially distributed over the entire second frequency band.

15. One or more non-transitory computer-readable storage media comprising computer-executable instructions, wherein the instructions, when executed, cause one or more processors to perform the method of claim 7.

16. The one or more non-transitory computer-readable storage media of claim 14, wherein the subcarriers of the plurality of first RUs are interleaved such that a subcarrier of one of the plurality of first RUs is an immediately adjacent subcarrier of another one of the plurality of first RUs.

17. The one or more non-transitory computer-readable storage media of claim 15, wherein the first frequency band comprises a plurality of unusable subcarriers that are unusable for data and/or pilot transmission; and
wherein the subcarriers of each of the plurality of first RUs are equidistantly interleaved when the plurality of unusable subcarriers are uncounted.

18. The one or more non-transitory computer-readable storage media of claim 14, wherein the first frequency band comprises a plurality of unusable subcarriers that are unusable for data and/or pilot transmission; and
wherein the unusable subcarriers and the plurality of first RUs in the first frequency band are substantially aligned with unusable subcarriers and a plurality of second RUs in a second frequency band, respectively, the second frequency band comprising the first frequency band and having a second BW different from the first BW.

19. The one or more non-transitory computer-readable storage media of claim 14 further comprising:
transmitting or receiving second data using one or more second RUs of a plurality of second RUs in a second frequency band;
wherein the second frequency band comprises the first frequency band and has a second BW different from the first BW;
wherein the subcarriers of each of the one or more first RUs are substantially distributed over the entire first frequency band; and
wherein the subcarriers of each of the one or more second RUs are substantially distributed over the entire second frequency band.

20. The one or more non-transitory computer-readable storage media of claim 18, wherein the second data is transmitted in a physical layer protocol data unit (PPDU);
wherein the PPDU comprises a SIG field in a preamble of the PPDU; and
wherein the SIG field comprises an indication indicating that a portion of the second frequency band is also used as the first frequency band.
